(19) United States
(12) Patent Application Publication
(10) Pub. No.: US 2020/0088965 A1
(43) Pub. Date: Mar. 19, 2020

(54) CABLE CONDUIT

(71) Applicant: COMMSCOPE TECHNOLOGIES LLC, Hickory, NC (US)

(72) Inventors: Matthew J. HOLMBERG, Hickory, NC (US); Kathleen TERRYLL, Hickory, NC (US); James J. SOLHEID, Hickory, NC (US); James J. BRANDT, Hickory, NC (US)

(73) Assignee: COMMSCOPE TECHNOLOGIES LLC, Hickory, NC (US)

(21) Appl. No.: 16/471,491

(22) PCT Filed: Dec. 20, 2017
(86) PCT No.: PCT/US2017/067726

§ 371 Date: Jun. 19, 2019

Related U.S. Application Data
(60) Provisional application No. 62/438,671, filed on Dec. 23, 2016.

(51) Int. Cl. G02B 6/44

(52) U.S. Cl. CPC G02B 6/4459

(57) ABSTRACT

A cable conduit can be unrolled from a reel and cut to length and includes longitudinal sections of a mounting portion and a covering portion that form an openable and closable channel therebetween, the mounting portion and covering portion being coupled together by a connector. In some examples, a support leg is provided to prop up the covering portion when the channel is mounted and in an open configuration.

### CROSS-REFERENCE TO RELATED APPLICATION

This application is being filed on Dec. 20, 2017 as a PCT International Patent Application and claims the benefit of U.S. Patent Application Ser. No. 62/438,671, filed on Dec. 23, 2016, the disclosure of which is incorporated herein by reference in its entirety.

### BACKGROUND

Cable conduits are used to hold, protect, and in some cases conceal cabling. Cabling is sometimes run or is installed in corners of walls, ceilings, and/or floors of new or existing structures. In conventional cable conduit systems, the process of introducing and securing cables inside the conduit can be cumbersome, imprecise, and/or time consuming. Improvement of cable conduits is desired.

### SUMMARY

The present disclosure relates to a cable conduit, such as a cable conduit for holding fiber optic cables.

In one embodiment of a cable conduit according to the present disclosure, a cable conduit has an open configuration and a closed configuration, and includes a mounting portion and a covering portion, the covering portion being coupled to the mounting portion by a connector. In some examples, the covering portion includes a support leg configured to prop the covering portion against the mounting surface to thereby form a channel in the conduit's open configuration in which to lay cable. In the open configuration, the channel is accessible through a gap between the mounting portion and the covering portion; in the closed configuration, the gap between the mounting portion and the covering portion is closed off. In some examples, a flexibly resilient connector joins the covering portion and the mounting portion. In some examples, a hinge joins the covering portion and the mounting portion. In some examples, a joint between the mounting portion and the covering portion is expandable. In some examples, an expansion piece can form a bridge between the mounting portion and the covering portion. The bridge can be adjustable, enabling a degree of selectivity in forming the cable conduit about the cable(s) that can be tailored to, e.g., the size, number, and/or configuration of cables running along the conduit. In some examples, the cable conduit includes a latch securing the covering portion to the mounting portion in the closed configuration of the cable conduit. The latch can be releasable such that the cable conduit can be converted back and forth between the open configuration and the closed configuration. In some examples, one or more portions of the cable conduit, such as the covering portion, is sufficiently flexible to bend around the cable(s) laid in the channel to enable the closed configuration of the cable conduit, and sufficiently resilient to return the cable conduit to the open configuration upon release of the covering portion in the closed configuration. In some examples, the cable conduit can also have a dispensing configuration. In some examples, the dispensing configuration can include a longitudinal strip of the cable conduit spooled around a rotating dispenser, such as a reel. The longitudinal strip of the cable conduit can be dispensed, e.g., unrolled, in segments of desired length and “cut to length.” Thus, in some examples, the cable conduit is sufficiently flexible to be spooled.

### BRIEF DESCRIPTION OF THE DRAWINGS

FIG. 1 is a schematic cross-sectional view of an example cable conduit in accordance with the present disclosure mounted to a mounting surface, the cable conduit being illustrated in an open configuration.

FIG. 2 is a schematic cross-sectional view of the cable conduit of FIG. 1 mounted to a mounting surface, the cable conduit being illustrated in a closed configuration.

FIG. 3 is a partial, schematic end view of the cable conduit of FIG. 1, the cable conduit being illustrated in a dispensing configuration.

FIG. 4 is a schematic end view of a further example of a cable conduit in accordance with the present disclosure, the cable conduit being illustrated in a dispensing configuration.

FIG. 5 is a schematic cross-sectional view of the cable conduit of FIG. 4 mounted to a mounting surface, the cable conduit being illustrated in an open configuration.

FIG. 6 is a schematic perspective view of the cable conduit of FIG. 4 mounted to a mounting surface, the cable conduit being illustrated in an open configuration.

FIG. 7 is a schematic cross-sectional view of the cable conduit of FIG. 4 mounted to a mounting surface, the cable conduit being illustrated in a closed configuration.

FIG. 8 is a flowchart illustrating an example method of using a cable conduit in accordance with the present disclosure.

### DETAILED DESCRIPTION

Reference will now be made in detail to example aspects of the present disclosure that are illustrated in the accompanying drawings. Wherever possible, the same reference numbers will be used throughout the drawings to refer to the same or like parts.

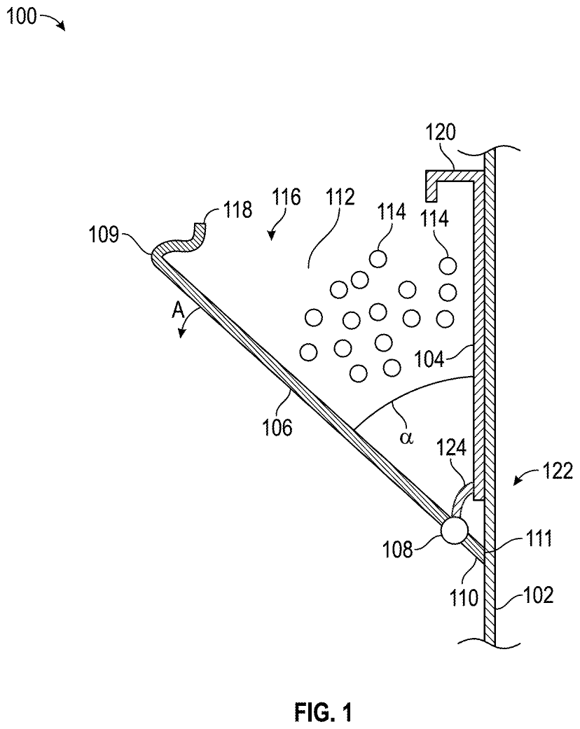

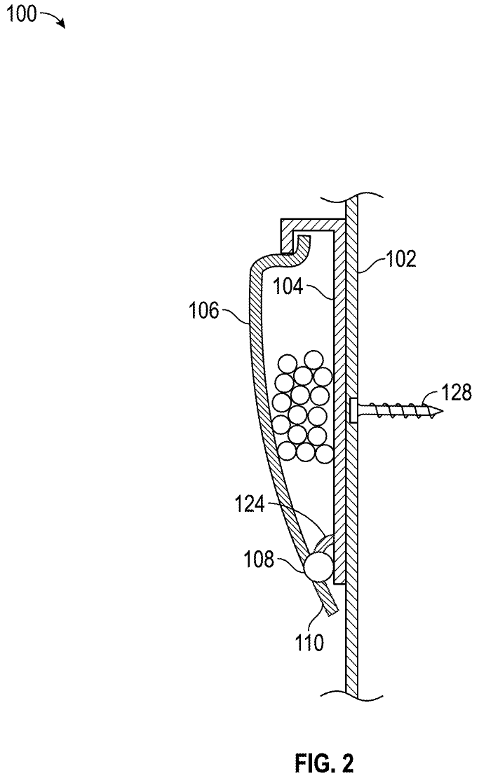

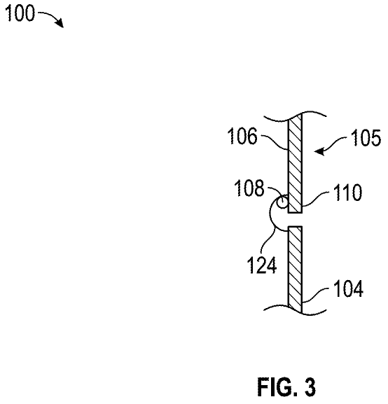

FIG. 1 is a schematic cross-sectional view of an example cable conduit 100 in accordance with the present disclosure mounted to an example mounting surface 102, the cable conduit being illustrated in an open configuration. FIG. 2 is a schematic cross-sectional view of the cable conduit 100 of FIG. 1 mounted to the mounting surface 102, the cable conduit being illustrated in a closed configuration. FIG. 3 is a partial, schematic end view of the cable conduit 100 of FIG. 1, the cable conduit being illustrated in a dispensing configuration.

With reference to FIGS. 1-3, the cable conduit 100 mounts to a surface 102, such as a surface of a wall, floor, or ceiling. The cable conduit 100 is designed for use in routing optical fibers and/or fiber optic cables within the interior of a building. The cable conduit 100 is also designed for use in routing fibers and/or cables at the exterior of a building.

The cable conduit 100 includes a mounting portion 104 and a covering portion 106, the covering portion 106 being coupled to the mounting portion 104 by a hinge 108. The mounting portion 104 includes a surface 105 that can abut the mounting surface 102. The hinge 108 can be a multiple-piece hinge, such as a pin and knuckle hinge or another type of pivot (e.g., a flexibly resilient joint, longitudinally continuous and integral with both the mounting portion 104 and the covering portion 106) between the mounting portion 104 and the covering portion 106 that enables the covering portion 106 to pivot relative to the mounting portion 104 without detaching therefrom.

The covering portion 106 has a first end 109 and a second end 111 opposing the first end 109, the hinge 108 being disposed between the first end 109 and the second end 111. In this example, the covering portion 106 includes a support leg 110. Alternatively, the support leg 110 can be considered its own component distinct from the covering portion 106 and being connected to the covering portion 106 by the hinge 108. The free end of the support leg 110 corresponds to the second end 111 and is configured to prop the covering portion 106 against the mounting surface 102. In other examples, the hinge 108 can include another type of locking mechanism that prevents rotation of the covering portion 106 in the direction labeled A in FIG. 1 beyond a predetermined maximum distance, and without the need for the support leg 110.

The length of the support leg 110 can determine the angle α between the mounting portion 104 and the covering portion 106 when the cable conduit 100 is in the open configuration shown in FIG. 1. A relatively long support leg 110 provides for a relatively small angle α, while a relatively short support leg 110 provides for a relatively large angle α. The size of the angle α partially determines the size and configuration of the channel 112 in the open configuration of the cable conduit 100 in which one or more cables 114 are placed.

In the open configuration (FIG. 1), the channel 112 is accessible through a gap 116 between the mounting portion 104 and the covering portion 106; in the closed configuration (FIG. 2), the gap between the mounting portion and the covering portion is closed off.

To enable the cable conduit to stay in the closed position, a first latching component 118 (e.g., a hook) disposed at an end of the covering portion 106 is configured to releasably engage a corresponding second latching component 120 (e.g., a catch) on the mounting portion 104. The first latching component 118 can be releasable from the second latching component 120 such that the cable conduit 100 can be converted back and forth between the open configuration and the closed configuration.

Referring to FIG. 1, in some examples, the joint 122 between the mounting portion 104 and the covering portion 106 is expandable. For example, an expansion piece 124 can form a bridge between the mounting portion 104 and the covering portion 106, or between the mounting portion 104 and the hinge 108, the hinge 108 being attached to, or integral with, the covering portion 106. The expansion piece 124 can be adjustable (e.g., stretchable), enabling a degree of selectivity in forming the cable conduit 100 about the cable(s) 114 that can be tailored to, e.g., the size, number, and/or configuration of cables 114 running through the conduit 100. The expansion piece 124 is not required, however. In alternative examples, the mounting portion 104 and the covering portion 106 are both attached to, or integral with, the hinge 108.

In some examples, one or more portions of the cable conduit 100, such as the covering portion 106, is sufficiently flexible to bend around the cable(s) 114 laid in the channel 112 to enable the closed configuration of the cable conduit (FIG. 2), and sufficiently resilient to return the cable conduit 100 to the open configuration (FIG. 1) upon release of the covering portion 106 in the closed configuration. In the closed configuration, the support leg 110 need not contact the mounting surface 102 (FIG. 2).

In some examples, the cable conduit 100 can also have a dispensing configuration (FIG. 3). In the dispensing configuration, the mounting portion 104 and the covering portion 106 are substantially parallel to each other and in the same plane (i.e., in a transverse direction, the mounting portion 104 and the covering portion 106 are substantially aligned end to end). In some examples, the dispensing configuration can include a longitudinal strip of the cable conduit 100 that is spooled around a rotating dispenser, such as a reel. With reference to FIG. 3, the longitudinal direction of a strip of the cable conduit 100 in the dispensing configuration is into and out of the page. The longitudinal strip of the cable conduit 100 can be dispensed, e.g., unrolled, in segments of desired length and “cut to length.” Thus, in some examples, the cable conduit 100 is sufficiently flexible to be spooled in the dispensing configuration shown in FIG. 3, and to adopt the open configuration of FIG. 1 and the closed configuration of FIG. 2. In addition, just as the conduit 100 can return to the open configuration from the closed configuration, in some examples it can also return to the dispensing configuration from the open configuration.

In some examples, the cable conduit 100 is it least partially formed from a polymer in an extrusion process, the extruded conduit being windable about a spool for dispensing.

The cable conduit 100 can be mounted to the mounting surface 102 in any suitable fashion. For example, an adhesive can be applied to the mounting surface side of the mounting portion 104. Alternatively, the adhesive can be applied to the mounting surface itself. The adhesive can include material suitable for adhesion to an exterior surface of a building or an interior surface of a building. A removable (e.g., by peeling), spoolable backing layer can cover the adhesive until the conduit 100 is ready for use, at which point the removable layer is removed to expose the adhesive. In addition to, or as an alternative to, an adhesive, other mounting means, such as one or more screws 128 (FIG. 2), bolts, nails, staples, or the like, can be inserted through the mounting portion 104 and the mounting surface 102 to secure the cable conduit 100 to the mounting surface 102.

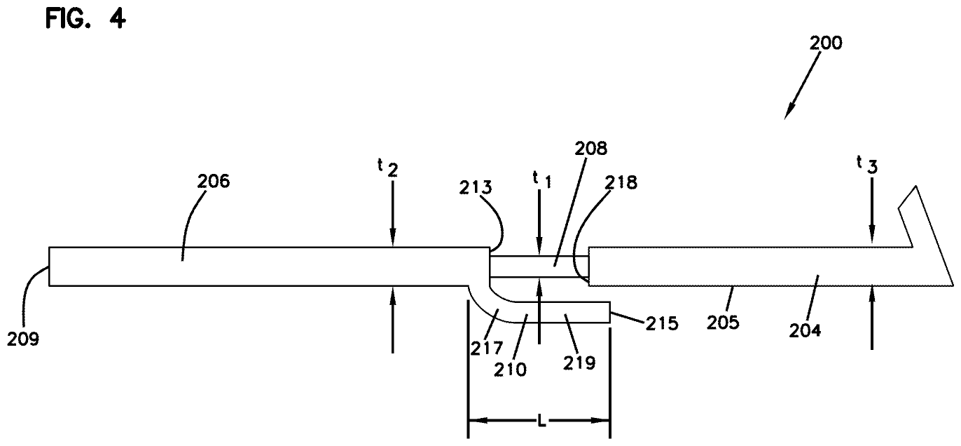

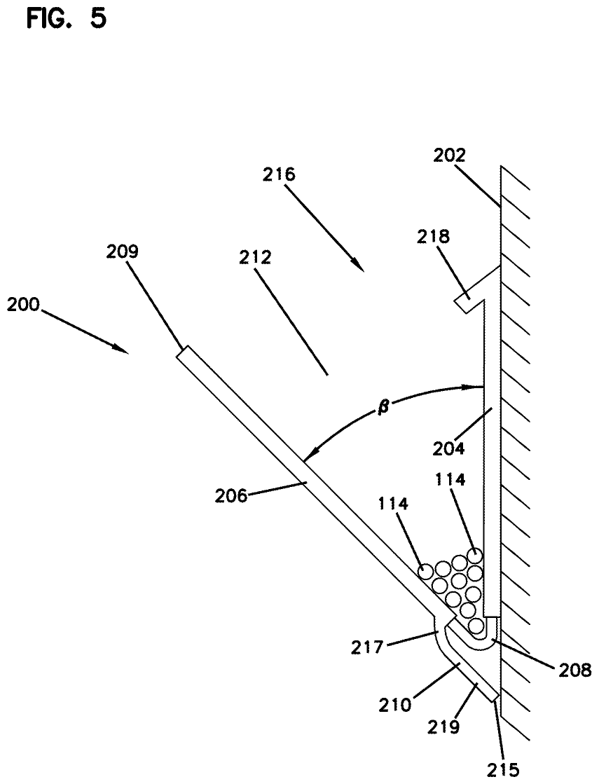

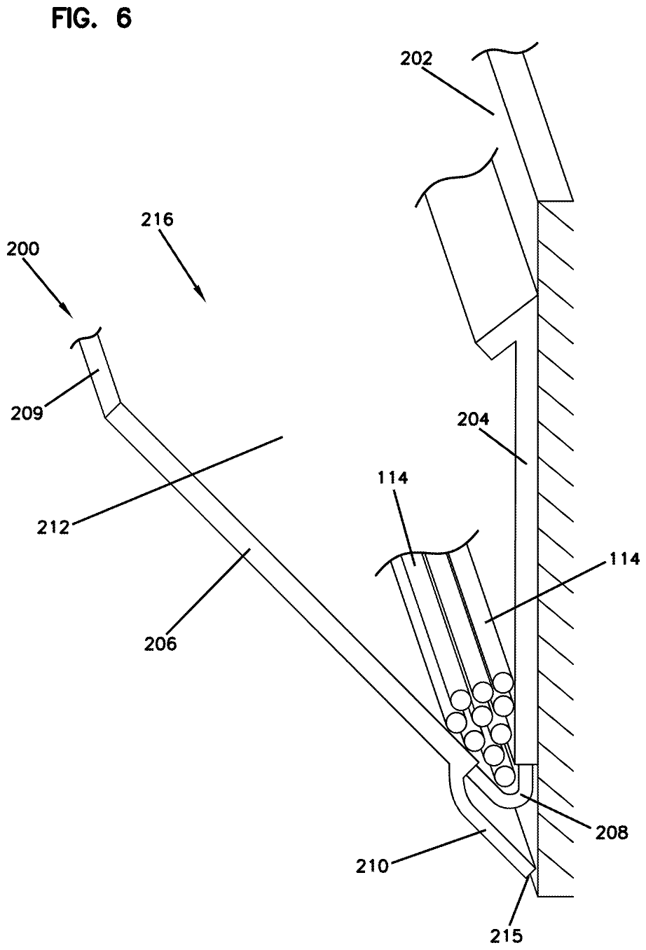

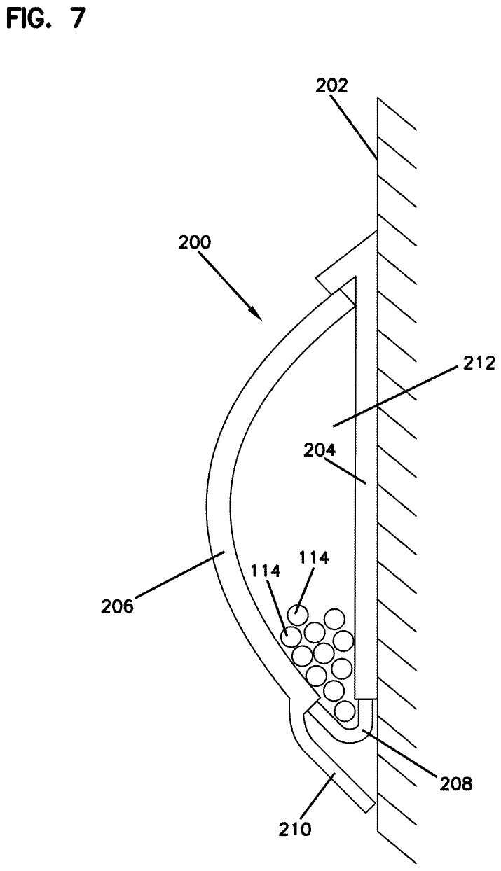

FIG. 4 is a schematic end view of a further example of a cable conduit 200 in accordance with the present disclosure, the cable conduit being illustrated in a dispensing configuration. FIG. 5 is a schematic cross-sectional view of the cable conduit 200 of FIG. 4 mounted to a mounting surface, the cable conduit being illustrated in an open configuration. FIG. 6 is a schematic perspective view of the cable conduit 200 of FIG. 4 mounted to a mounting surface, the cable conduit being illustrated in an open configuration. FIG. 7 is a schematic cross-sectional view of the cable conduit of FIG. 4 mounted to a mounting surface, the cable conduit being illustrated in a closed configuration.

With reference to FIGS. 4-7, the cable conduit 200 mounts to a surface 202, such as a surface of a wall, floor, or ceiling. The cable conduit 200 is designed for use in routing optical fibers and/or fiber optic cables (e.g., cables 114) within the interior of a building. The cable conduit 200 is also designed for use in routing fibers and/or cables at the exterior of a building.

The cable conduit 200 includes a mounting portion 204 and a covering portion 206, the covering portion 206 being coupled to the mounting portion 204 by a connector 208. The mounting portion 204 includes a surface 205 that can abut the mounting surface 202. The connector 208 is a flexibly resilient piece of material (e.g., an elastomer or polymer) that connects an end 211 of the mounting portion 204 to an end 213 of the covering portion 206. The connector 208 can be longitudinally (i.e., into and out of the page in FIG. 4) continuous with both the mounting portion 204 and the covering portion 206, such that when a piece of the conduit 200 is cut to length from a reel, the length of conduit includes equal lengths of the mounting portion 204, the covering portion 206 and the connector 208, i.e., the mounting portion, covering portion and connector are coextensive and continuous. In some examples, the connector 208 is formed (e.g., extruded together as a unitary construction with the covering portion 206 and the mounting portion 204) of the same material or materials as the covering portion 206 and the mounting portion 204, with the exception of having a transverse thickness t₁ that is less than the corresponding transverse thickness t₂ or t₃ of the covering portion 206 and the mounting portion 204, respectively. In these examples the reduced thickness of the connector 208 can provide the flexibility required to adequately manipulate the conduit 200 between and among the dispensing configuration, the open configuration, and the closed configuration. The connector 208 enables the covering portion 206 to pivot relative to the mounting portion 204 without detaching therefrom.

The covering portion 206 has a first end 209 (i.e., a free end) and a second end 213 opposite the first end 209, the connector 208 connecting to the second end 213. A support leg 210 extends from or approximately from the second end 213 to a free end 215. When the conduit 200 is mounted to a mounting surface 202 and in the open configuration, the free end 215 of the support leg 210 is configured to abut the mounting surface 202 and thereby to prop the covering portion 206 against the mounting surface 202. That is (referring to FIG. 5), the support leg 210 is configured to prop up the covering portion 206 to maintain the angle β even as cables are laid in the conduit.

The support leg 210 includes a curved portion 217 and a straight portion 219. A first end of the curved portion 217 abuts the covering portion 206. The straight portion 219 extends from a second end of the curved portion and terminates at the free end 215 of the support leg 210. In the dispensing configuration of the conduit 200, the straight portion 219 is parallel or substantially parallel to the covering portion 206 but not coplanar therewith.

In some examples, the support leg 210 is formed (e.g., extruded together as a unitary construction with the covering portion 206 and the mounting portion 204) of the same material or materials as the covering portion 206 and the mounting portion 204. For a given cut longitudinal length of the conduit 200, in some examples the mounting portion 204, covering portion 206, connector 208, and support leg 210 are longitudinally (i.e., into and of the page in FIG. 4) coextensive and continuous.

The length of the support leg 210 can determine the angle β between the mounting portion 204 and the covering portion 206 when the cable conduit 100 is in the open configuration shown in FIG. 1. A relatively long support leg 210 provides for a relatively small angle β, while a relatively short support leg 210 provides for a relatively large angle β. The size of the angle β partially determines the size and configuration of the channel 212 in the open configuration of the cable conduit 200 in which one or more cables 114 are placed.

In the open configuration (FIGS. 5-6), the channel 212 is accessible through a gap 216 between the mounting portion 204 and the covering portion 206; in the closed configuration (FIG. 7), the gap between the mounting portion and the covering portion is closed off.

To enable the cable conduit to stay in the closed position, a latching component 218 (e.g., a hook, a catch) disposed at an end of the mounting portion 204 is configured to releasably engage the free end 209 of the covering portion 206. The free end 209 of the covering portion 206 can be releasable from the latching component 218 (e.g., by deforming the covering portion 206) such that the cable conduit 200 can be converted back and forth between the open configuration and the closed configuration.

In some examples, one or more portions of the cable conduit 200, such as the covering portion 206, is sufficiently flexible to bend around the cable(s) 114 laid in the channel 212 to enable the closed configuration of the cable conduit (FIG. 7), and sufficiently resilient to return the cable conduit 200 to the open configuration (FIG. 5) upon release of the covering portion 206 in the closed configuration.

In the dispensing configuration (FIG. 4), the mounting portion 204 and the covering portion 206 are substantially parallel to each other and in the same plane (i.e., in the transverse direction, the mounting portion 204 and the covering portion 206 are substantially aligned end to end). In some examples, the dispensing configuration can include a longitudinal strip of the cable conduit 200 that is spooled around a rotating dispenser, such as a reel. With reference to FIG. 4, the longitudinal direction of a strip of the cable conduit 200 in the dispensing configuration is into and out of the page. The longitudinal strip of the cable conduit 200 can be dispensed, e.g., unrolled, in segments of desired length and “cut to length.” Thus, in some examples, the cable conduit 200 is sufficiently flexible to be spooled in the dispensing configuration shown in FIG. 4, and to adopt the open configuration of FIG. 5 and the closed configuration of FIG. 7. In addition, just as the conduit 200 can return to the open configuration from the closed configuration, in some examples it can also return to the dispensing configuration from the open configuration.

In some examples, the cable conduit 200 is it least partially formed from a polymer in an extrusion process, the extruded conduit being windable about a spool for dispensing.

The cable conduit 200 can be mounted to the mounting surface 202 in any suitable fashion. For example, an adhesive can be applied to the mounting surface side 205 of the mounting portion 204. Alternatively, the adhesive can be applied to the mounting surface itself. The adhesive can include material suitable for adhesion to an exterior surface of a building or an interior surface of a building. A removable (e.g., by peeling), spoolable backing layer can cover the adhesive until the conduit 200 is ready for use, at which point the removable layer is removed to expose the adhesive. In addition to, or as an alternative to, an adhesive, other mounting means, such as one or more screws, bolts, nails, staples, or other fasteners, can be inserted through the mounting portion 204 and the mounting surface 202 to secure the cable conduit 200 to the mounting surface 202.

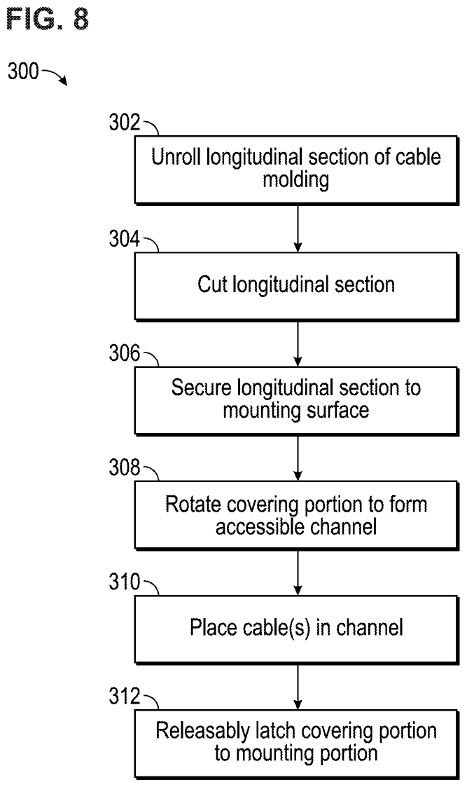

FIG. 8 is a flowchart illustrating an example method 300 of using the cable conduits (100, 200) of FIGS. 1-7.

In the example method 300, in an operation 302, a longitudinal section of desired length of the cable conduit (100, 200) is unrolled from a reel.

In an operation 304, the longitudinal section is cut to the desired length.

In an operation 306, the mounting portion (104, 204) of the longitudinal section is secured to a surface (102, 202).

In an operation 308, the covering portion (106, 206) is pivoted about the hinge 108 or connector 208 into a position such that a channel (112, 212), accessible by a gap (116, 216), is formed between the mounting portion (104, 204) and the covering portion (106, 206), and such that a free end of a support leg (110, 210) props up the covering portion (106, 206) against the surface (102, 202).

In an operation 310, one or more cables 114 are placed in the channel (112, 212).

In an operation 312, a latching component (118, 218) is engaged to releasably couple a free end of the covering portion (106, 206) to the mounting portion (104, 204) to close off the channel (112, 212) and thereby create a closed configuration for the cable conduit (100, 200).

Devices and methods consistent with the disclosure make possible the fabrication, installation, and use of cable/fiber carriers for optical networks. The foregoing description of example features provides illustration and description, but is not intended to be exhaustive or to limit the invention to the precise form disclosed. Modifications and variations are possible in light of the above teachings or may be acquired from practicing the disclosures.

For example, implementations consistent with the principles of the invention can be implemented using other types of fabrication techniques, and assembly methods other than those illustrated in the figures and described in the specification without departing from the spirit of the disclosures. Furthermore, additional features can be added, or removed, depending on specific deployments, applications, and the needs of users and/or service providers.

No element, act, or instruction used in the description of the invention should be construed as critical or essential to the invention unless explicitly described as such. Also, as used herein, the article “a” is intended to include one or more items.

1. A cable conduit for housing at least one cable, the cable conduit comprising an open configuration and a closed configuration and further comprising:
a mounting portion;
a covering portion;
a connector pivotally connecting the covering portion to the mounting portion; and
a support leg extending from the covering portion and terminating at a free end, the free end configured to abut against a mounting surface when the cable conduit is secured to the mounting surface in the open configuration.

2. The cable conduit of claim 1, wherein a channel is formed between the mounting portion and the covering portion when the cable conduit is in the open configuration, and wherein in the open configuration the cable conduit comprises a gap between the mounting portion and the covering portion for placing one or more cables in the channel.

3. The cable conduit as in claim 1, wherein the gap is closed off in the closed configuration.

4. The cable conduit as in claim 1, further comprising an expansion piece forming a bridge between the mounting portion and the covering portion, the expansion piece configured for selectively expanding a channel formed between the mounting portion and the covering portion.

5. The cable conduit as in claim 1, wherein at least one of the mounting portion and the covering portion comprises a latching component configured to releasably couple the covering portion and the mounting portion in the closed configuration.

6. The cable conduit as in claim 1, further comprising a dispensing configuration, wherein at least a portion of the mounting portion and the covering portion are parallel to each other and in the same plane when the cable conduit is in the dispensing configuration.

7. The cable conduit of claim 6, wherein the cable conduit is wrapped around a dispensing reel when the cable conduit is in the dispensing configuration.

8. The cable conduit as in claim 1, further comprising a dispensing configuration, wherein ends of the mounting portion and the covering portion are transversely aligned when the cable conduit is in the dispensing configuration.

9. The cable conduit of claim 8, wherein the cable conduit is wrapped around a dispensing reel when the cable conduit is in the dispensing configuration.

10. The cable conduit as in claim 1, wherein an adhesive is applied to the mounting portion for securing the cable conduit to the mounting surface.

11. The cable conduit as in claim 1, wherein the connector is a hinge.

12. The cable conduit as in claim 1, wherein the connector has a thickness that is less than a corresponding thickness of at least one of the mounting portion and the covering portion.

13. The cable conduit of as in claim 1, wherein the covering portion, the mounting portion, and the support leg are coextensive and continuous in a longitudinal direction, and wherein the connector has a transverse thickness that is less than a transverse thickness of at least one of the mounting portion and the covering portion.

14. The cable conduit as in claim 1, wherein the support leg comprises a curved portion and a straight portion, a first end of the curved portion abutting the covering portion, the straight portion extending from a second end of the curved portion and terminating at the free end.

15. The cable conduit of claim 14, wherein in a dispensing configuration the straight portion of the support leg is at least substantially parallel to the covering portion but not longitudinally coplanar with the covering portion.

16. The cable conduit as in claim 1, wherein a length of the support leg determines a magnitude of an angle formed between the covering portion and the mounting portion when the cable conduit is in the open configuration.

17. The cable conduit as in claim 1, wherein the covering portion, the mounting portion, the connector and the support leg form a unitary construction.

18. The cable conduit as in claim 1, wherein the covering portion, the mounting portion, and the support leg are coextensive and continuous in a longitudinal direction.

19. A method for housing cable in a cable conduit comprising the steps of:
unrolling from a reel a longitudinal section of the cable conduit;
cutting the longitudinal section from the reel;
securing a mounting portion of the longitudinal section of the cable conduit to a mounting surface;
pivoting a covering portion of the longitudinal section of the cable conduit about a connector coupling the covering portion to the mounting portion to from a channel accessible by a gap between the covering portion and the mounting portion;
placing at least one cable in the channel; and
releasably latching the covering portion to the mounting portion to close off the gap, wherein the covering portion comprises a support leg, the support leg being configured to rest against the mounting surface when the gap is open.
